(19) United States
(12) Patent Application Publication
(10) Pub. No.: US 2008/0012853 A1
(43) Pub. Date: Jan. 17, 2008

(54) Generating mesh from implicit surface

(76) Inventor: William Geiger, San Francisco, CA (US)

Correspondence Address: FISH & RICHARDSON, PC, P.O. BOX 1022, MINNEAPOLIS, MN, 55440-1022, US

(21) Appl. No.: 11/486,761

(22) Filed: Jul. 14, 2006

(51) Int. Cl. G06T 17/00

(52) U.S. Cl. 345/420; 345/424

(57) ABSTRACT

A computer-implemented method for generating a mesh from an implicit surface for use in animation includes obtaining a first data collection that corresponds to an implicit surface included in a spatial domain, wherein a mesh is to be created for the implicit surface. The method includes recursively subdividing the spatial domain into voxels to identify those of the voxels that the implicit surface intersects. The method includes generating the mesh for the implicit surface using the identified voxel faces. The voxels may be stored in a sparse voxel array and the subdivision can be performed in branches, wherein only a currently subdivided branch is held in memory.

### TECHNICAL FIELD

This document relates to generating a mesh from an implicit surface.

### BACKGROUND

Computer-based animation techniques often involve one or more digital meshes that are configured to assume a desired shape and thereafter forwarded to a rendering component that generates the picture frames that will be assembled into the final animation. Along the way, the meshes are typically “painted” with the appearance they should have, such as the looks of a particular character or the colors of an object in nature such as a tree or an ocean wave.

To animate realistic-looking waves and other bodies of water, there is sometimes used fluid simulation engines that are programmed to simulate the appearance and behavior of a fluid. The output of such a simulation engine may be an implicit surface, such as a set of function values defined for a domain to represent the location and speed of the water at a given moment in time.

Some attempts have been made to render surfaces for animation from the output of such fluid simulation engines. One example is ray tracing, which typically involves calculating the effect that lights have on the surface of objects in the scene, and using this result in the rendering. However, ray tracing may not be able to efficiently handle implicit surfaces defined by a particle set and may make shader displacement difficult. Another approach is known as the dual-contour method, but this has not produced a high enough resolution or good enough temporal coherence to render a turbulent ocean or to interact with detailed and complicated computer graphics models.

### SUMMARY

The invention relates to generating a mesh. For example, it is shown that a mesh can be generated from an implicit surface for use in animation.

In a first general aspect, a computer-implemented method for generating a mesh from an implicit surface for use in animation includes obtaining a first data collection that corresponds to an implicit surface included in a spatial domain, wherein a mesh is to be created for the implicit surface. The method includes recursively subdividing the spatial domain into voxels to identify those of the voxels that the implicit surface intersects. The method includes generating the mesh for the implicit surface using the identified voxel faces.

Implementations may include any or all of the following features. The voxel faces can be quadrilateral. The recursive subdivision can be done by successively reducing voxel sizes a predetermined number of times. The voxel sizes can be reduced using an octree data structure. The recursive subdivision can be done in several branches among the voxels, and only one of the branches that is currently being subdivided can be held in memory. The method can further include storing the voxels that the implicit surface intersects in an array that is indexed for identifying adjacent ones of the voxels. The voxels that the implicit surface intersects can be identified by evaluating vertices of the voxels. The vertices can be associated with faces of the voxels, and the method can further include identifying those of the voxel faces that have all their vertices outside the implicit surface, and generating the mesh from the vertices of the identified voxel faces. The mesh can be generated by discarding any of the voxel faces having any of their vertices inside the implicit surface. The method can further include discarding any of the voxel faces that directly adjoins another voxel. The method can further include performing vertice sharing between at least two of the voxel faces. Two voxel faces of a common voxel can share a vertice. When first and second ones of the voxels have respective voxel faces that are adjacent, the adjacent voxel faces can share at least one of the vertices. When first and second ones of the voxels have no respective voxel faces that are adjacent, the first and second voxels can share none of the vertices. Registration of the vertices for the voxel faces can be performed using a recursive algorithm. When a first one of the voxels has at least a first vertex, the recursive algorithm can include identifying at least a second one of the voxels that adjoins the first voxel directly and not diagonally, and causing the second voxel to reference the first vertex. The recursive algorithm can further include identifying, for the second voxel, at least a third one of the voxels that adjoins the second voxel directly and not diagonally, and causing the third voxel to reference the first vertex. When each of the identified voxels is associated with at least one of several vertices, generating the mesh can include identifying, for each of the vertices, a new location at a nearest point on the implicit surface. The nearest points can be determined by calculating a value and derivative of a function that generates the implicit surface. When at least one of the vertices is a non-shared vertex, the method can further include identifying at least two new locations on the implicit surface for the non-shared vertex. The method can further include performing a mesh relaxation at least once on the generated mesh. When each of the identified voxels is associated with at least one of several vertices, the mesh relaxation can even out a distribution of the vertices and reduce local curvature of the generated mesh. When a first one of the vertices has several neighboring vertices, the mesh relaxation can further include determining an average position of the neighboring vertices and moving the first vertex toward the average position. The method can further include performing a triangulation on the generated mesh. The method can further include recursively subdividing the triangulated mesh into spatial regions so that each of the spatial regions has at most a predetermined number of vertices. When each of the identified voxels is associated with at least one of several vertices and when sharing of the vertices between at least two of the voxel faces is done, the method can further include determining, for each voxel face that shares one of the vertices, an average of normals of those voxel faces, and calculating blended vertex normals from the determined average. When the implicit surface is a levelset, and also a second data collection corresponding to splash particles in the spatial domain is received, the first and second data collections can be used in the recursive subdivision and in generating the mesh.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example of a computer graphic generation system.

FIGS. 2A-F show examples of input, output, and intermediate stages of a mesh generating process schematically.

FIG. 3 is a flowchart showing an example of a method for generating a frame from one or more implicit surfaces.

FIG. 4 is a block diagram of a computing system that can be used in connection with computer-implemented methods described in this document.

Like reference symbols in the various drawings indicate like elements.

### DETAILED DESCRIPTION

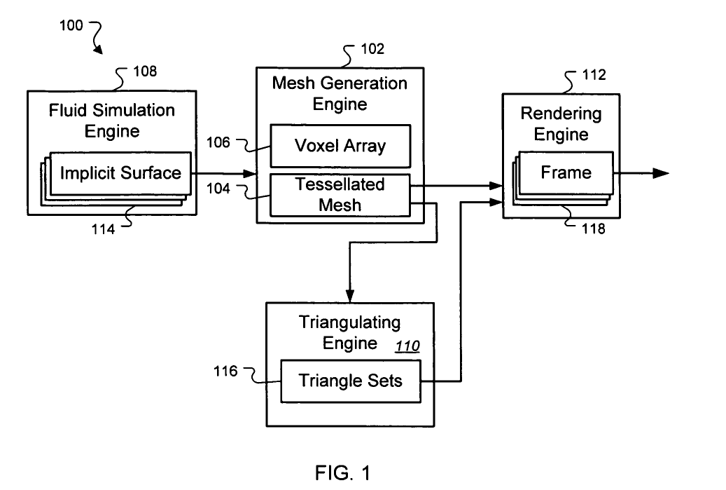

FIG. 1 shows a computer system 100 that is capable of generating picture frames using implicit surfaces. Particularly, the system 100 can generate the implicit surfaces to simulate the appearance of a fluid and then process that surface to generate the frames that are to be assembled in the animation. The computer system 100 includes a mesh generation engine 102 that may process one or more implicit surfaces to generate a tessellated mesh 104 for use in rendering a picture frame. In some implementations, the mesh generation engine 102 is configured to recursively subdivide a spatial domain containing the implicit surface into voxels. In so doing, the mesh generation engine 102 can identify voxels that intersect the implicit surface and store the identified voxels in a voxel array 106. Using the identified voxel faces, the mesh generation engine 102 generates the tessellated mesh 104.

The computer system 100 also includes a fluid simulation engine 108, a triangulating engine 110, and a rendering engine 112. In some implementations, the fluid simulation engine 108 may be configured to simulate motion of fluids (e.g., gas, ocean, water, etc.). The fluid simulation engine 108 can then generate one or more implicit surfaces 114 (e.g., an isosurface) that separate, for example, ocean and air in a spatial domain. The fluid simulation engine 108 may generate implicit surfaces based on, for example a set of parameters (e.g., flow speed, wind speed, initial state of the fluid, time elapsed, etc.). In some implementations, the fluid simulation engine 108 may generate hybrid implicit surfaces that include more information than an isosurface. For example, the generated implicit surfaces 114 may include a level set and a large particle set. The level set may be an isosurface in a spatial domain that separates a fluid and other elements in the domain. The large particle set may be a set of, for example, water particles, which can be difficult to be represent by a level set. In some implementations, the implicit surfaces 114 may also include velocity information of the implicit surfaces 114.

The mesh generation engine 102 receives the one or more implicit surfaces 114 and generates the tessellated mesh 104 by filling voxels in the spatial domain. In some implementations, a voxel represents a sub-volume box (e.g., a cube) having volumetric values representing a scalar/vector value of the corresponding grid/pixel in the spatial domain. The mesh generation engine 102 recursively subdivides the spatial domain into voxels by, for example, subdividing larger voxels that are identified to be intersecting the implicit surfaces 114 in the spatial domain. In some implementations, the mesh generation engine 102 may continue to subdivide the voxels for a predetermined number of levels (e.g., 3, 5, 10 levels). In some implementations, an octree data structure is used such that the voxel is subdivided into eight subvoxels, each of which in turn can be subdivided into eight more and so on.

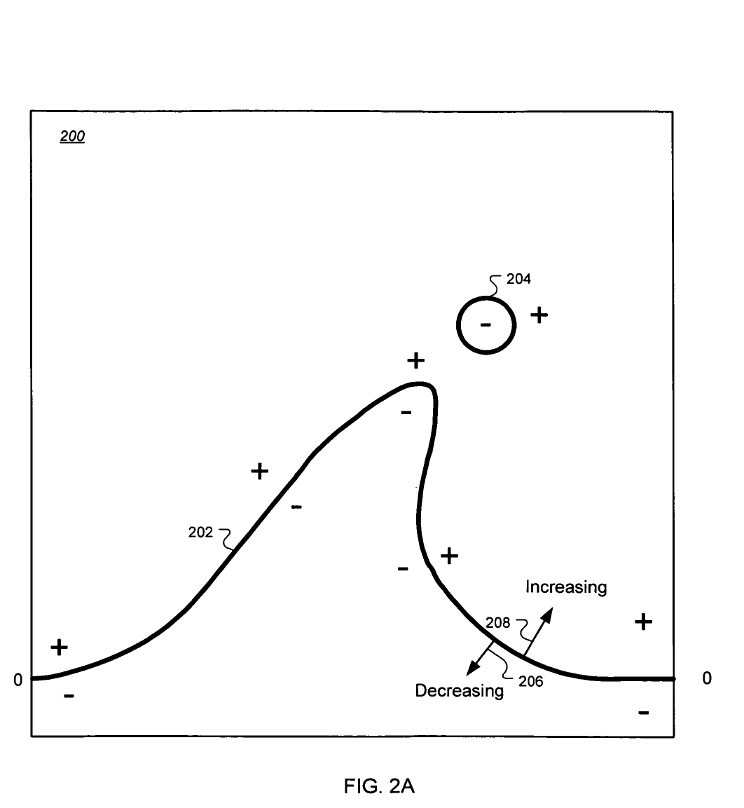

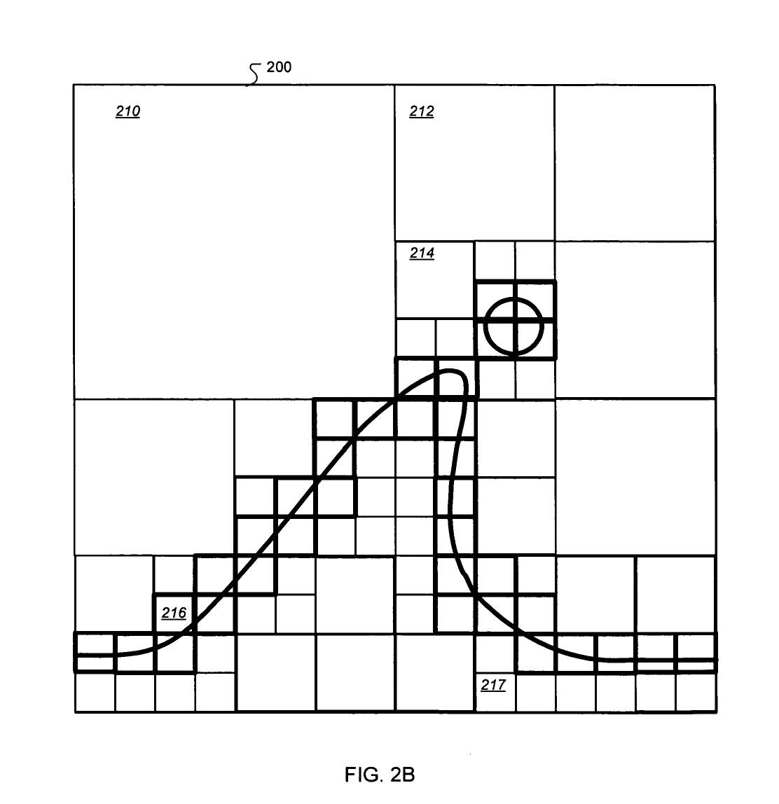

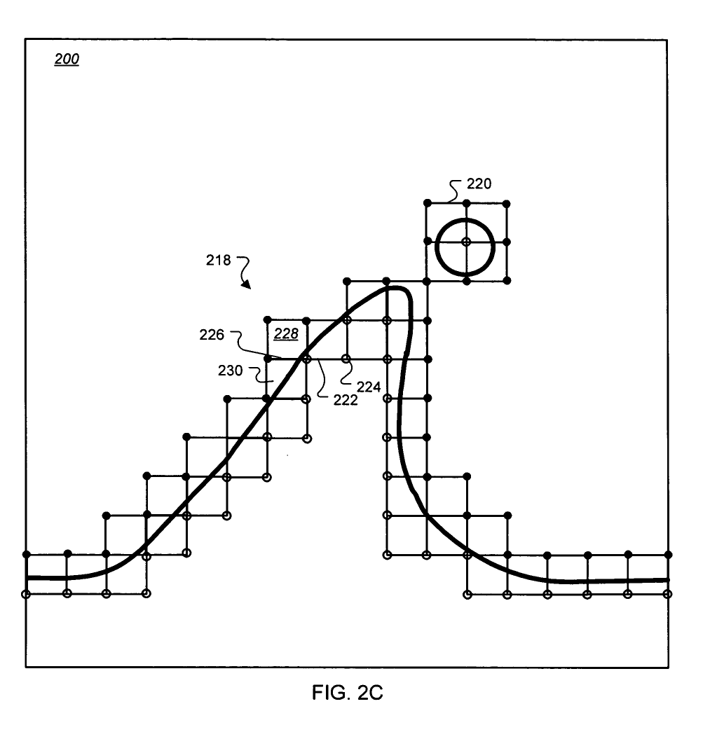

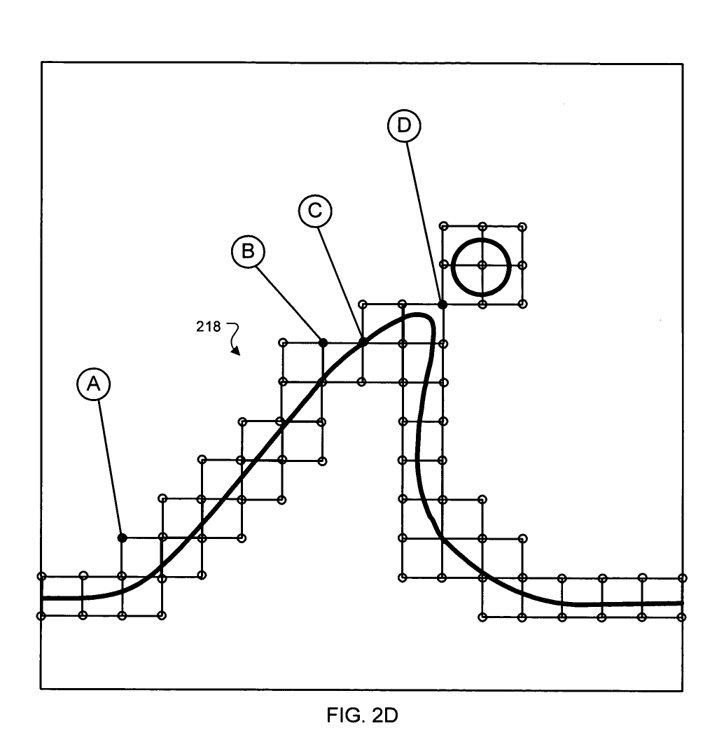

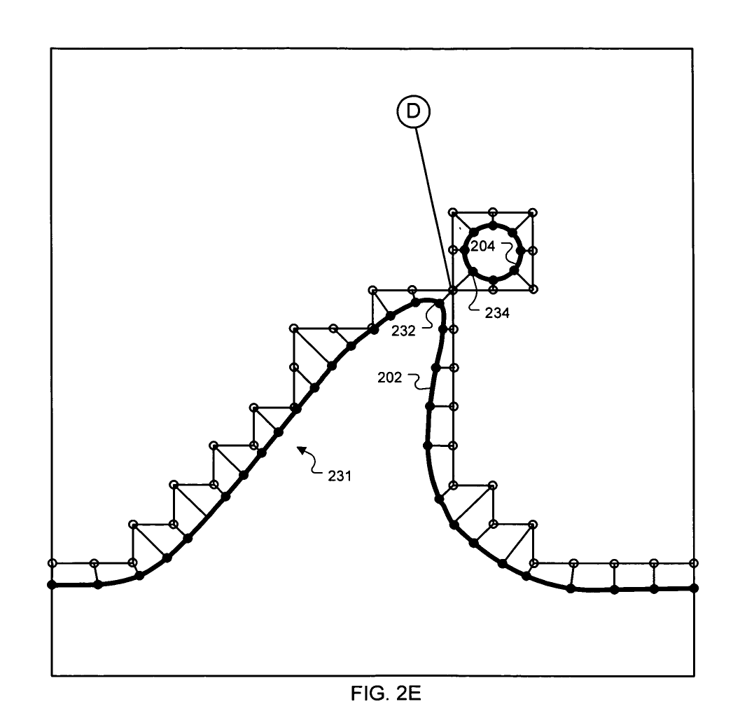

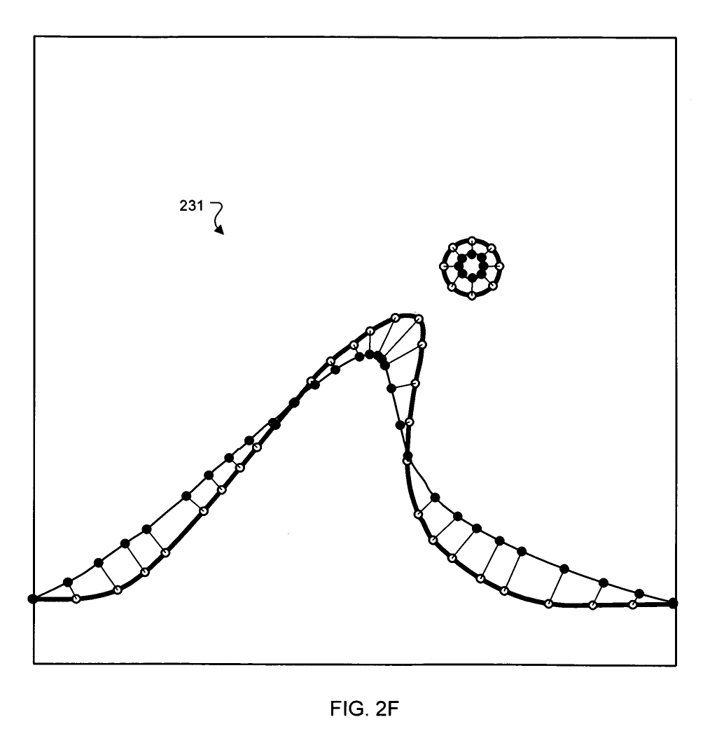

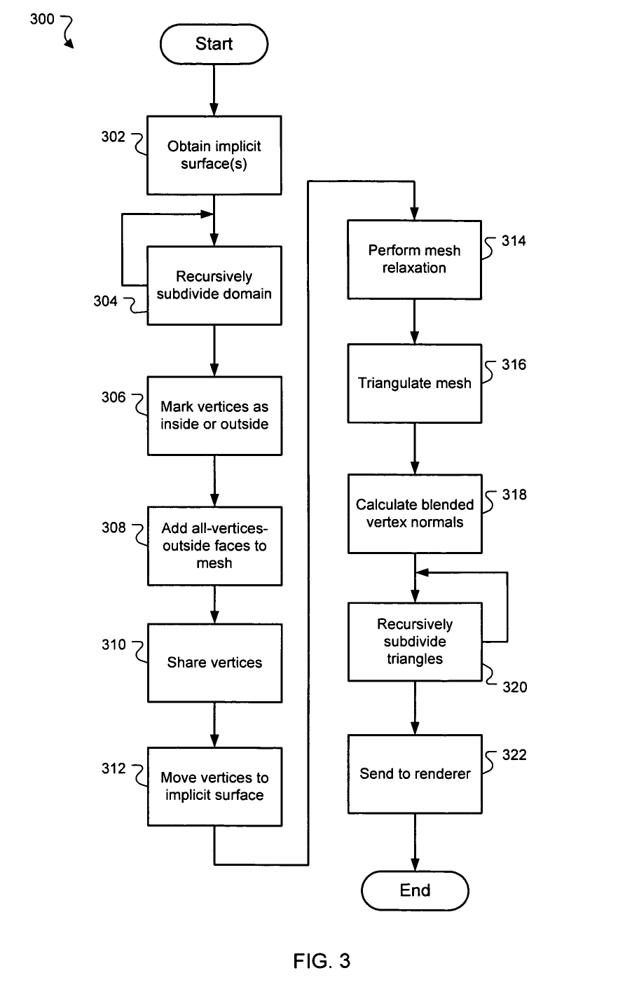

In some implementations, only the currently subdivided branch is held in memory of the mesh generation engine 102. Thus, only a small subset of the total voxels in the spatial domain is stored and the effective voxel resolution is increased. The mesh generation engine 102 stores the finest voxels that the implicit surface intersects in the voxel array 106. For example, the voxel array 106 may be a sparse voxel array. For example, the voxel array may be implemented using known techniques such as a C++ standard template library (STL). In some implementations, the three coordinates (XYZ) of the voxel are converted into a single 64-bit index. This index is used as the key for an STL associative array (map).From the voxel array 106, the mesh generation engine 102 generates the tessellated mesh 104. Examples of a method to generate the tessellated mesh 104 from the one or more implicit surfaces 114 are described with reference to FIGS. 2-3.

The generated mesh 104 can be sent directly to the rendering engine 112 for rendering. The rendering engine 112 generates picture frames 118 from a model, which includes the tessellated mesh 104, the triangle sets 116, and/or other parameters. For example, the model may include description of geometry, viewpoint, texture and lighting information of the objects in the spatial domain. In some implementations, the rendering engine 112 may generate a final appearance of a computer generated object in an animation. The rendering engine 112 may produce picture frames in computer and video games, simulators, movies or TV special effects, design visualization, and/or other animation applications. In some implementations, the frames 118 may be used to integrate with other computer graphic objects, forming a picture with several computer graphic objects.

In some circumstances, the generated mesh 104 is too large to be handled by the rendering engine 112 as a single subdivision surface mesh, or the renderer does not support quadrilateral subdivision surface meshes. In these and optionally other situations, the generated mesh 104 can be sent to the triangulating engine 110 for triangulation. The triangulating engine 110 triangulates and blends vertex normals in the tessellated mesh 104. For example, each voxel in the tessellated mesh 104 may be divided into triangles. The triangles are recursively subdivided into spatial regions that each contain no more than a maximum number of vertices, forming one or more spatially coherent triangle sets 116. The triangle sets 116 are then sent to the rendering engine 112. In some implementations, arbitrarily large tessellated meshes may be rendered using the triangulating engine 110. The triangulating engine 110 may send the triangle sets 116 to the rendering engine 112 on demand, reducing a load of the rendering engine 112 during rendering process of a large mesh.

FIGS. 2A-F show a schematical representation of an exemplary spatial domain 200 containing multiple implicit surfaces 202, 204. The surface 202 represents an ocean wave and the surface 204 a droplet of water. More particularly, the domain 200 here corresponds to the orientation of the wave and the droplet at an instance that may correspond to a single frame of the animation. To generate several frames, then, multiple versions of the implicit surfaces would be generated.

Here, the spatial domain 200 and the implicit surfaces are shown as two dimensional for clarity. However, a mesh generating process may be a three dimensional process in some examples. Accordingly, the example shown in FIGS. 2A-F can be viewed as a cross-section of the domain and surfaces that are involved in such a three-dimensional processing. The implicit surfaces 202, 204 may be generated by the fluid simulation engine 108. Using the implicit surfaces 202, 204, the mesh generation engine 102 may execute steps as schematically illustrated in FIGS. 2A-F to generate a tessellated mesh 104.

As shown in FIG. 2A, the implicit surfaces 202, 204 may divide the spatial domain 200 into areas of water and areas of elements other than water. The implicit surfaces 202, 204 may provide each point in the spatial domain 200 with a value. In the depicted example, if the value at a point is positive, the point is not water. If the value at a point is negative, the point is water. If the value is zero, the point is on the implicit surface. The collection of points having a zero value may form a level set. In the depicted example, when the point is further away from the implicit surface, the value of the points increases as shown by an arrow 206. In contrast, when the point is further inside the object as shown by an arrow 208, the value of the points decreases. This configuration of the implicit surfaces will be processed to generate a mesh that can be used in the animation of the wave.

As shown in FIG. 2B, the mesh generation engine 102 may perform a recursive subdivision operation in the spatial domain 200. In the depicted example, the mesh generation engine 102 may initially generate four large voxels for the spatial domain 200. In this example, it will be assumed that if the voxels were shown as having three dimensions, they could be subdivided in eight large voxels. Here, a voxel 210 in the spatial domain 200 shows the size of each large voxel. For each voxel that intersects with at least one of the implicit surfaces 202, 204, the voxel is further subdivided into four smaller voxels, including among them a voxel 212. Recursively, each of the voxels that intersects with any one of the implicit surfaces 202, 204 are subdivided into further smaller voxels, such as a voxel 214. In some implementations, the recursive subdivision process may be done a predetermined number of times, depending on the required resolution of the mesh or the capacity of the voxel array. Here, the spatial domain 200 is subdivided four times, resulting in smallest voxels 216 in the areas nearest to the implicit surfaces 202, 204. Here, those of the voxels 216 that intersect the implicit surfaces 202, 204 are highlighted. By contrast, a voxel 217 is one that does not intersect the surfaces and is not highlighted.

In some implementations, the mesh generation engine 102 performs this operation by evaluating the four vertices of each voxel. If the calculated values at all vertices are of the same sign (e.g., all positive or all negative), then the mesh generation engine 102 determines that the voxel does not intersect any of the implicit surfaces 202, 204. In contrast, if at least one calculated value at the vertices has a different sign than the calculated value at another vertex, then the mesh generation engine 102 determines that the voxel intersects with at least one of the implicit surfaces 202, 204.

In some implementations, all voxels intersected by the implicit surfaces (shown in FIG. 2B as bolded voxels) are added to a sparse voxel array after the finest level of subdivision is completed. For example, the mesh generation engine 102 may store a row number and a column number of a voxel that intersects the implicit surfaces 202, 204. For example, for the voxel 216, which is located in the third row and the third column, the mesh generation engine 102 may store the values (3, 3) as one of the elements in the sparse array.

In some implementations, the mesh generation engine 102 may store the voxel filled in the spatial domain 200 using a tree structure. For each recursive subdivision operation, the mesh generation engine 102 may only held branches that are currently being subdivided in memory to reduce memory load. For a three dimensional process, each voxel may be divided into eight reduced sized voxels. Therefore, the mesh generation engine 102 may use an octree data structure to perform recursive subdivision in the three dimensional process.

Because only the voxels in the finest level that intersects at least one of the implicit surfaces are retained for further processing, the effective voxel resolution is increased. Also, the voxel resolution is completely decoupled form the resolution of any of the implicit surfaces 202, 204.

FIG. 2C shows a connected mesh 218 that the mesh generation engine 102 may construct using the retained voxels. In some implementations, the mesh generation engine 102 may identify a set of exterior voxel faces from the voxels in the voxel array to construct the mesh 218. For example, the mesh generation engine 102 may evaluate vertices of the voxels in the voxel array. In FIG. 2C, the vertices that are evaluated to be outside of the implicit surfaces 202, 204 are labeled using a filled dot and the vertices that are evaluated to be in at least one of the implicit surfaces 202, 204 are labeled using an unfilled dot. In this two-dimensional example, each voxel has four faces. In a three-dimensional implementation, each voxel can have six faces.

If a voxel face have all its vertices outside the implicit surface (e.g., all vertices result in a positive value after evaluating with the implicit surface function), then the voxel face is identified as an exterior voxel face and is added to the mesh 218. For example, a voxel face 220 is an exterior voxel face because the voxel face 220 has both vertices outside of the implicit surfaces 202, 204. If a voxel face has one or more of its vertices inside any of the implicit surfaces 202, 204, the voxel face is discarded. For example, a voxel face 222 is not an exterior voxel face because a vertex 224 is inside the implicit surface 202. Also, if a voxel face directly adjoins another voxel, the voxel face is discarded. For example, a voxel face 226 is discarded because the voxel face 226 adjoins a voxel 228 and a voxel 230.

In some implementations, the mesh generation engine 102 performs vertex sharing operations to ensure that the mesh 218 is a smoothly blended mesh at render time. As shown in FIG. 2D, each voxel structure may store up to a fixed number of vertices (e.g., four or eight vertices) that are used by its voxel faces. Some vertices may be used by more than one voxel face. By identifying the shared vertices, the mesh generation engine 102 can ensure that the mesh 218 is smoothly blended. For example, voxel faces of the same voxel always share a vertex (e.g., a vertex labeled A). In another example, if two voxels have adjacent voxel faces, all vertices (e.g., a vertex labeled B) on those voxel faces are shared. In another example, if two voxels have indirectly adjacent voxel faces, all vertices (e.g., a vertex labeled C) on those voxel faces are shared. In another example, for voxels that are not adjacent to each other, vertices (e.g., a vertex labeled D) are not shared between their voxel faces.

Before a vertex is created at a voxel, the mesh generation engine 102 checks that the same vertex has not been created and referenced by the voxel or other voxels in the voxel array. For example, when a new vertex is to be created for a voxel face, the mesh generation engine 102 may perform a recursive operation to share the newly created vertex appropriately with other voxel faces. In some implementations, after a vertex is created, the mesh generation engine 102 may set a voxel that is currently referencing the newly created vertex as the current voxel. The mesh generation engine 102 may then create references to the created vertex from voxels that directly adjoin the current voxel along an axis (but not diagonally). Next, the mesh generation engine 102 updates the voxels that are directly adjacent to the current voxel as the current voxels. Then, the mesh generation engine 102 may recursively create references to the newly created vertex in the voxels that directly adjoin the current voxels. The operations are recursively performed until all voxels that should share the vertex have been identified. An example of the operation is described with reference to FIG. 3.

As shown in FIG. 2E, the mesh generation engine 102 then uses the created vertices to generate a quadrilateral mesh 231 that approximates the implicit surfaces 202, 204. In some implementations, the vertices that remain after the preceding processing steps are moved to a closest point on the implicit surface(s). As shown in FIG. 2E, several points (shown as filled dots) on the implicit surfaces 202, 204, each being closest to a vertex (shown as unfilled dots), is added to the quadrilateral mesh 231. In some implementations, the closest point on the implicit surface from each vertex may be determined by calculating a value and a derivative of the implicit surface function. For example, the mesh generation engine 102 may generate a normal from the implicit surface to the vertex and determine a closest point from the vertex on the implicit surface.

For a non-shared vertex, the mesh generation engine 102 may identify at least two new locations on the implicit surfaces 202, 204. For example, a vertex labeled D is not shared between voxels as mentioned with reference to FIG. 2D. This means that the vertex may be relevant for more than one implicit surface, or for more than one region of a single implicit surface. Here, the vertex is projected to a point 232 on the implicit surface 202 and also to a point 234 on the implicit surface 204.

The mesh generation engine 102 may perform a mesh relaxation operation on the mesh 231 at least once. The mesh relaxation operations may even out a distribution of the vertices and reduce local curvature of the mesh 231. Additionally, the mesh relaxation operations may simulate surface tension effects, reduce artifacts, and create a smooth blending between the different implicit surfaces 202, 204. FIG. 2F shows an exemplary result of a mesh relaxation operation. The original vertex positions of the quadrilateral mesh 231 are shown as unfilled dots and examples of the resulting vertex positions after mesh relaxation are shown as filled dots. In some implementations, the mesh generation engine 102 may use a simple vertex averaging scheme to perform the mesh relaxation operation. For example, the mesh generation engine 102 may identify several neighboring vertices for each vertex. Then, the mesh generation engine 102 may move a position of the vertex to a position that is an average position of the neighboring vertices. In some implementations, this operation is repeated until the desired level of smoothing at the mesh 231 is achieved. Other mesh relaxation algorithms can be used.

The resulting mesh 231 is then sent either to the rendering engine 112 or to the triangulating engine 114 for further processing.

FIG. 3 is a flow chart of exemplary operations 300 for generating a mesh from an implicit surface for use in animation. The operations 300 can be performed by a processor executing instructions stored in a computer program product. The operations 300 begin in step 302 with obtaining a first data collection that corresponds to one or more implicit surfaces included in a spatial domain, wherein a mesh is to be created for the implicit surface. For example, the mesh generation engine 102 may obtain the implicit surface 114 from the fluid simulation engine 108. In step 304, the operations 300 comprise recursively subdividing the domain. For example, the mesh generation engine 102 may recursively subdivide the spatial domain 200 by successively reducing voxel size as shown in FIG. 2B. This step can also include storing of selected voxels in an array.

After the subdivision of the domain reaches a predetermined level (e.g., after 10 subdivisions), the operations 300 marks vertices as inside or outside in step 306. For example, the mesh generation engine 102 may mark vertices of the smallest voxel resulting from the recursive subdivision as inside vertices or exterior vertices. For example, the mesh generation engine 102 may evaluate the value provided by the implicit surface at each vertex. If the provided value is positive, for example, the vertex may be classified as an exterior vertex. Otherwise, the vertex may be classified as an inside vertex.

Next, the operations 300 add, in step 308, the all-vertices-outside faces to a mesh. For example, the mesh generation engine 102 may add voxel faces to the mesh 218 if all vertices of the voxel faces are exterior vertices as described with reference to FIG. 2C. In step 310, the operations 300 share the vertices appropriately. For example, the mesh generation engine 102 may identify the shared vertices to ensure that the mesh 218 is smoothly blended as described with reference to FIG. 2D. In some implementations, if a vertex is to be created and added to a voxel data structure, the mesh generation engine 102 may recursively share the newly created vertex with other voxels appropriately.

The operations 300 then move vertices to the implicit surface in step 312. For example, the mesh generation engine 102 may move the vertices to the closest point on the implicit surfaces 202, 204 using a value and a derivative of the implicit surface function as described with reference to FIG. 2E. In step 314, the operations 300 perform mesh relaxation. For example, the mesh relaxation operation may be the mesh relaxation operation performed by the mesh generation engine 102. For example, the mesh generation engine 102 may perform the mesh relaxation operation at least once to even out a distribution of the vertices and reduce local curvature of the mesh 231.

In step 316, the operations 300 triangulate the mesh. For example, the triangulating engine 110 may triangulate the mesh 104. Next, the operations 300 calculate, in step 318, blended vertex normals. For example, the triangulating engine 110 may calculate blended vertex normals from the average of the normals of the faces that share each vertex. The operations 300 then recursively subdivide triangles in step 320. For example, the triangulating engine 110 may first divide each quadrilateral voxel face into two triangular faces and then recursively subdivide the triangular faces in to smaller triangular faces, creating the triangle sets 116.

In some implementations, each of the voxels included in the mesh 231 is associated with at least one of several vertices. For each voxel face that share one of the vertices, the triangulating engine 110 determines an average of normals of those voxel faces and calculates blended vertex normals from the determined average. The triangulating engine 110 can then use the blended vertex normals to create a set of spatially coherent triangles (e.g., the triangle sets 116). In some situations, the triangulation steps 316-320 can be omitted.

In step 322, the operations 300 send a resulting mesh to a renderer. For example, the mesh generation engine 102 can send the tessellated mesh 104 to the rendering engine 112. In another example, the triangulating engine 110 sends the triangle sets 116 to the rendering engine 112 to generate the frame 118.

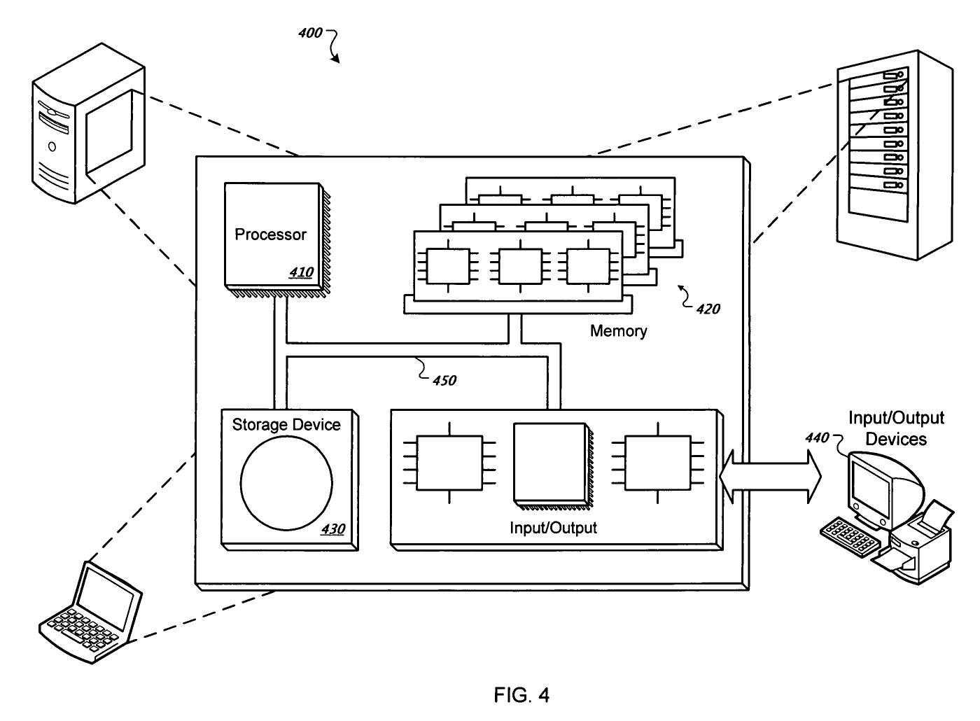

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for generating a mesh from an implicit surface for use in animation, the method comprising:
obtaining a first data collection that corresponds to an implicit surface included in a spatial domain, wherein a mesh is to be created for the implicit surface;
recursively subdividing the spatial domain into voxels to identify those of the voxels that the implicit surface intersects; and
generating the mesh for the implicit surface using the identified voxel faces.

2. The computer-implemented method of claim 1, wherein the voxel faces are quadrilateral.

3. The computer-implemented method of claim 1, wherein the recursive subdivision is done by successively reducing voxel sizes a predetermined number of times.

4. The computer-implemented method of claim 3, wherein the voxel sizes are reduced using an octree data structure.

5. The computer-implemented method of claim 3, wherein the recursive subdivision is done in several branches among the voxels, and wherein only one of the branches that is currently being subdivided is held in memory.

6. The computer-implemented method of claim 1, further comprising storing the voxels that the implicit surface intersects in an array that is indexed for identifying adjacent ones of the voxels.

7. The computer-implemented method of claim 1, wherein the voxels that the implicit surface intersects are identified by evaluating vertices of the voxels.

8. The computer-implemented method of claim 7, wherein the vertices are associated with faces of the voxels, further comprising identifying those of the voxel faces that have all their vertices outside the implicit surface, and generating the mesh from the vertices of the identified voxel faces.

9. The computer-implemented method of claim 8, wherein the mesh is generated by discarding any of the voxel faces having any of their vertices inside the implicit surface.

10. The computer-implemented method of claim 9, further comprising discarding any of the voxel faces that directly adjoins another voxel.

11. The computer-implemented method of claim 7, further comprising performing vertice sharing between at least two of the voxel faces.

12. The computer-implemented method of claim 11, wherein two voxel faces of a common voxel share a vertice.

13. The computer-implemented method of claim 11, wherein first and second ones of the voxels have respective voxel faces that are adjacent, and wherein the adjacent voxel faces share at least one of the vertices.

14. The computer-implemented method of claim 11, wherein first and second ones of the voxels have no respective voxel faces that are adjacent, and wherein the first and second voxels do not share any of the vertices.

15. The computer-implemented method of claim 11, wherein registration of the vertices for the voxel faces is performed using a recursive algorithm.

16. The computer-implemented method of claim 15, wherein a first one of the voxels has at least a first vertex, and wherein the recursive algorithm comprises identifying at least a second one of the voxels that adjoins the first voxel directly and not diagonally, and causing the second voxel to reference the first vertex.

17. The computer-implemented method of claim 16, wherein the recursive algorithm further comprises identifying, for the second voxel, at least a third one of the voxels that adjoins the second voxel directly and not diagonally, and causing the third voxel to reference the first vertex.

18. The computer-implemented method of claim 1, wherein each of the identified voxels is associated with at least one of several vertices, and wherein generating the mesh includes identifying, for each of the vertices, a new location at a nearest point on the implicit surface.

19. The computer-implemented method of claim 18, wherein the nearest points are determined by calculating a value and derivative of a function that generates the implicit surface.

20. The computer-implemented method of claim 19, wherein at least one of the vertices is a non-shared vertex, further comprising identifying at least two new locations on the implicit surface for the non-shared vertex.

21. The computer-implemented method of claim 1, further comprising performing a mesh relaxation at least once on the generated mesh.

22. The computer-implemented method of claim 21, wherein each of the identified voxels is associated with at least one of several vertices, and wherein the mesh relaxation evens out a distribution of the vertices and reduces local curvature of the generated mesh.

23. The computer-implemented method of claim 21, wherein a first one of the vertices has several neighboring vertices, and wherein the mesh relaxation comprises determining an average position of the neighboring vertices and moving the first vertex toward the average position.

24. The computer-implemented method of claim 1, further comprising performing a triangulation on the generated mesh.

25. The computer-implemented method of claim 24, further comprising recursively subdividing the triangulated mesh into spatial regions so that each of the spatial regions has at most a predetermined number of vertices.

26. The computer-implemented method of claim 24, wherein each of the identified voxels is associated with at least one of several vertices and wherein sharing of the vertices between at least two of the voxel faces is done, further comprising determining, for each voxel face that shares one of the vertices, an average of normals of those voxel faces, and calculating blended vertex normals from the determined average.

27. The computer-implemented method of claim 1, wherein the implicit surface is a levelset, and wherein also a second data collection corresponding to splash particles in the spatial domain is received, and wherein the first and second data collections are used in the recursive subdivision and in generating the mesh.

28. A computer program product tangibly embodied in an information carrier and comprising instructions that when executed by a processor perform a method for generating a mesh from an implicit surface for use in animation, the method comprising:
obtaining a first data collection that corresponds to an implicit surface included in a spatial domain, wherein a mesh is to be created for the implicit surface;
recursively subdividing the spatial domain into voxels to identify those of the voxels that the implicit surface intersects; and
generating the mesh for the implicit surface using the identified voxel faces.
